(19) United States
(12) Patent Application Publication
(10) Pub. No.: US 2015/0381743 A1
(43) Pub. Date: Dec. 31, 2015

(54) System and Method for Dynamic Creation of Distribution Network Software Applications

(71) Applicant: AutoApp, LLC, Denver, CO (US)

(72) Inventors: Jordan Hendry, Denver, CO (US); Michael Hendry, Golden, CO (US)

(73) Assignee: AutoApp, LLC, Denver, CO (US)

(21) Appl. No.: 14/751,597

(22) Filed: Jun. 26, 2015

Related U.S. Application Data
(60) Provisional application No. 62/017,990, filed on Jun. 27, 2014.

(51) Int. Cl. H04L 29/08; H04L 12/24

(52) U.S. Cl. CPC H04L 67/16; H04L 41/5041

(57) ABSTRACT

Software is provided to facilitate creation of organization content distribution networks by service account holders. Network creators have ability to accept or invite members to their network, placing contacts in groups containing interaction permissions. Resulting user application functionality and interfaces are dependent on selections made during network creation and, furthermore, associated user permissions. Members who have permissions to utilize a set of tools will receive a more advanced navigation interface than those members without such permissions. Decentralized content creation, curation, and distribution processes exist through submodule interaction via network creator or permissible contacts.

### CROSS-REFERENCE TO RELATED APPLICATIONS

This application claims priority to U.S. Provisional Patent Application No. 62/017,990 filed on Jun. 27, 2014, the entire disclosure of which is incorporated by reference as though fully set forth herein.

### FIELD OF THE INVENTION

This present invention relates to systems and methods for organizing and distributing digital data. More specifically, the present invention relates to systems and methods for optimizing the efficiency of organizing and distributing digital data via network systems.

### BACKGROUND

The use of social networks across the general population has increased dramatically in recent years. A corresponding need has arisen for efficient methods and techniques for creating custom social networks designed for distribution of digital content via a permission based folder management and repository curation system. Typically, a user utilizes listed methods to create groups of contacts for the purpose of selectively distributing uploaded digital content according to determined permission access, and to create different forms of software applications available through web, native desktop OS' (Windows 7/8, Mac OS X, etc.), and mobile OS's (iOS, Android, Windows Phone) sources. Improved methods are needed which allow restriction of access to either entire sub-application utilities inside the created organization network, or specific content contained within.

Creating software applications is cost intensive, while creating websites has become trivial. Small and medium sized businesses or groups are able to create quality web presences for little investment contrasted with development requirements for web, desktop, and mobile applications. While websites are great options to display static information, increasingly digital business practices world-wide call for interactive software connecting leaders to constituents, businesses to customers, and managers to employees.

Mobile devices have brought resurgence in native application software. Native software, found locally on an electronic device (as opposed to through a web browser), provides a level of quality and responsiveness as yet unmatched by web counterparts. The ability to have these forms of applications developed in conjunction with a web presence exponentially increases costs and development complexities. Accordingly, less complex and costly methods for developing such applications are needed.

The methods of the present invention solve the problem of an organization having to create its own suite of mobile, desktop, and online applications for private collaboration, communications, and distribution of digital assets. The organization does not have to solve problems related to application design, development, security, and deployment.

### BRIEF DESCRIPTION OF THE DRAWINGS

FIG. 1 is a block diagram illustrating a system for providing an online organizational network, according to an embodiment;

FIG. 2A is a flow diagram illustrating a method for creating a network organization in the system of FIG. 1 in accordance with an embodiment;

FIG. 2B is a flow diagram illustrating a method for creating a contact and optionally associating the contact to the network organization such as that from FIG. 2A in the system of FIG. 1 in accordance with an embodiment;

FIG. 2C is a flow diagram illustrating a method for creating or editing the permissions structure of contact group or content folder, defining an associated user interface used for interaction by a network organization member such as one assimilated through FIG. 2B on a network organization such as that from FIG. 2A in the system of FIG. 1;

FIG. 3A is a sample interface used in inputting information and selecting options to create a network organization;

FIG. 3B is a sample interface used in presenting an organization's request for user access;

FIG. 3C is a sample interface used in creating a contact group and setting the functionality the group may have; and

FIG. 3D is a sample interface used in creating a data folder and setting who has access to it.

### DETAILED DESCRIPTION OF THE INVENTION

Selected embodiments of the present invention will now be explained with reference to the accompanying figures. It will be apparent to those skilled in the art from this disclosure that the following descriptions are provided for illustration only and not for the purpose of limiting the invention as defined by the appended claims and the equivalents. Particular embodiments described herein provide a more appealing technical environment for sharing business unit or organization related material. In this environment, individuals who join the network organization may access material and functionalities as set forth by the network administrators. The different roles and duties that make up an organization are reflected in their interfaces capabilities of the network.

Preferably, the technical environment is accessed through native desktop, mobile, tablet, and web based applications, and the users are members of a system providing them enrollment access to their associated business' organization network. The deployment of this organization network is made possible by selections made during organization network creation, yielding varying sub-applications and navigational structures for the type of business or organization declared. An accounting firm would have an inherently different feature set than a legal office. The organization network administrators control the functionalities available to each of their members and the members' system users, thus dramatically impacting the individual user's interface and perceived system functionality for his or her individual embodiment. The resulting structure of the network created for the user's organization is responsive to the information provided by the organization's user.

The organizational network is generally defined by the roles different members of the organization play, and by the utility the network provides. An organizational network may be represented by a tree structure. Each node of the tree defines either contact hierarchies or sub-application order. Connections between contacts and sub-applications relate to access and different forms of interaction.

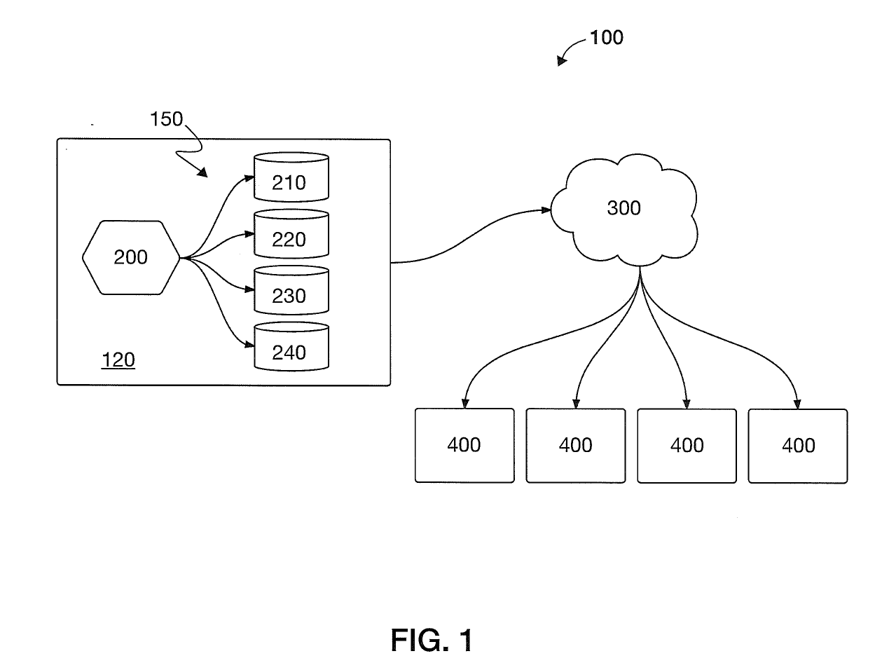

FIG. 1 is a block diagram illustrating a system 100 for creating and managing an online organization distribution network in accordance with an embodiment of the present invention. The network managing system 100 includes one or more computer . systems, an exemplary one of which is shown at 120 each computer system further including a plurality of databases 150, and an application server 200, which is operatively connected to a the database 150 and to a network 300, e.g. the Internet, and accessible over the network by a plurality of computers 400.

The application server 200 manages the plurality of databases 150 including but not limited to a user database 210, an organizations database 220, a navigation database 230, and an associations database 240. The user database 210 contains account and profile information for each of the member organizations and/or users who have registered with the service managed by the computer system. The profile information may include, among other things contact information such as: a unique user identifier, names, telephone numbers, email addresses, social media usernames, physical locations and descriptions, digital art, assets, organizational multi media assets, and other common organizational information or combinations of the foregoing.

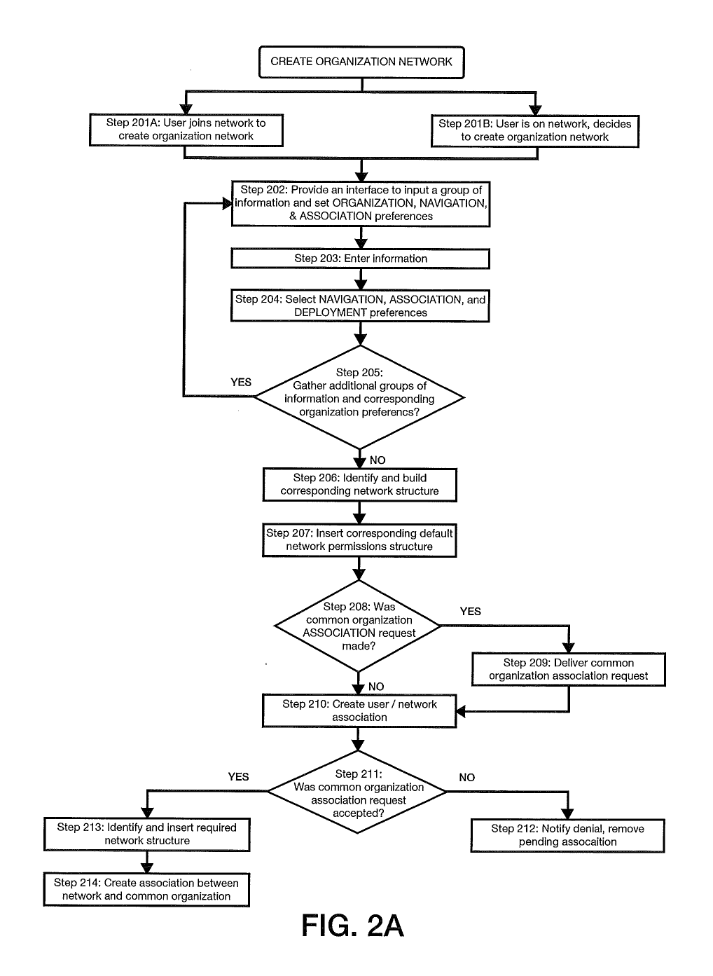

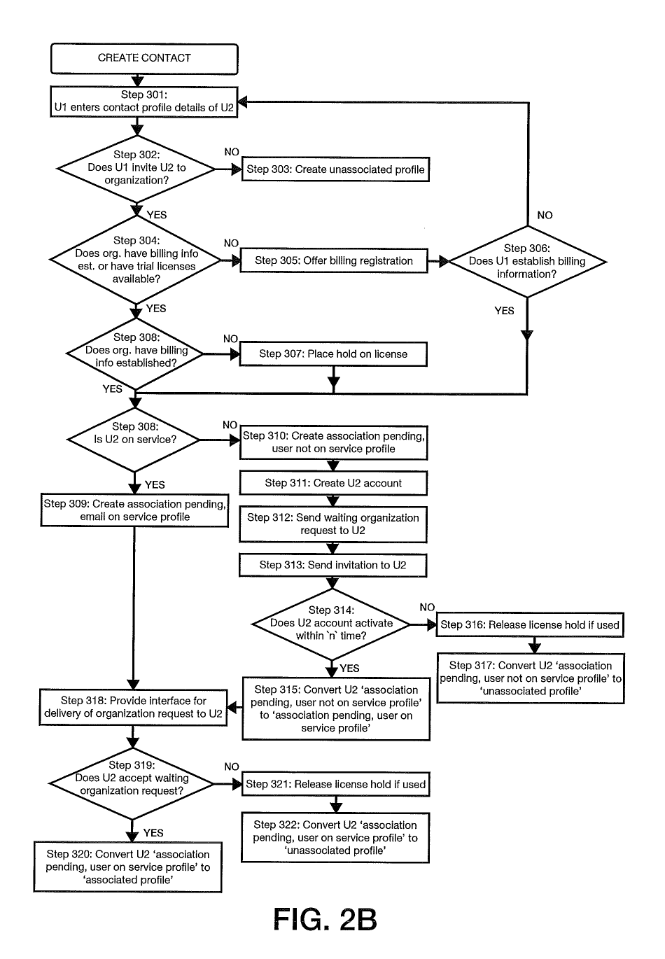

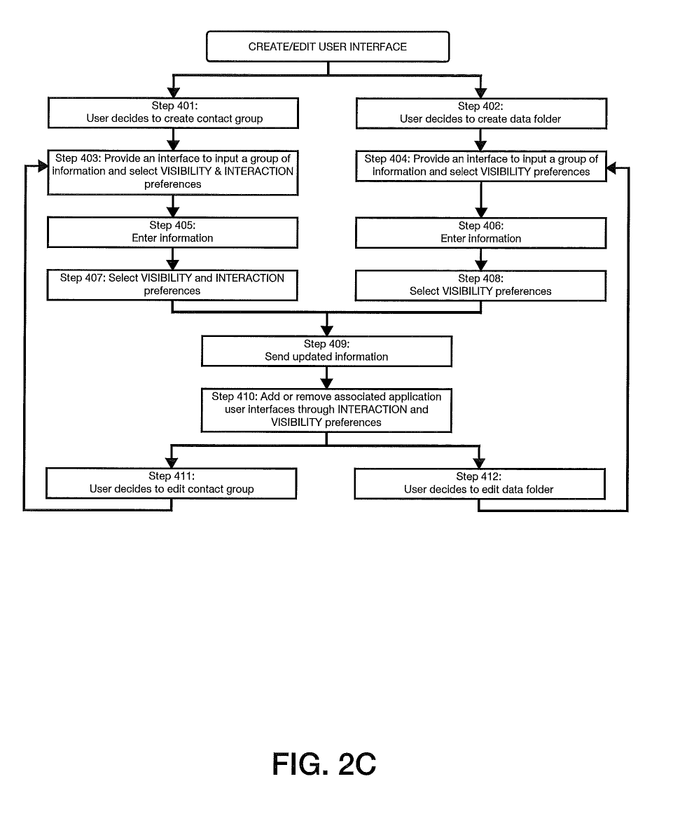

The organizations database 220 stores information relating to the sub-networks created on the system. This information may include a unique network identifier, member profile information, digital data assets, subscription information, access request structures, and permission structure, among other things. This information also includes ORGANIZATION, NAVIGATION, ASSOCIATION, VISIBILITY, and INTERACTION preferences, the uses of which are described below in greater detail in connection with databases 230 & 240, and as illustrated in the flow diagrams of FIGS. 2A & 2C.

The navigations database 230 stores structural information that helps build the sub-networks (also referred to as an organization network) deployed on the system. This information may include, by way of example and not of limitation: organization types, section architecture structures, contact folder hierarchies, default permission sets, imparted organizational requirements, and user interface (“UI”) presets.

The associations database 240 stores information relating to inter-sub-network communication and hand-shaking; which is a technical term describing the process by which two devices initiate communication with one another and establish a communication protocol. This information may include, among other things, relationship maps between existing organizations, sub-network organization requirements, and application to sub-network organization password information.

The contents of the user database 210, the organizations database 220, the navigations database 230, and the associations database 240 are updated as needed. The updates reflect informational inputs related to new users, organizations, navigations, and associations and edits of existing information made through computers 400.

Referring now to for FIG. 2A, a flow diagram is shown which illustrates a method for processing a request from a registered system member to create an online organization network (also referred to as a sub-network). In Steps 201A/B, the application server 200 responds to a request from a registered user (U1) to create a new organization network (ON1) on the system 100. This situation would arise if a registered user selected a corresponding interface element.

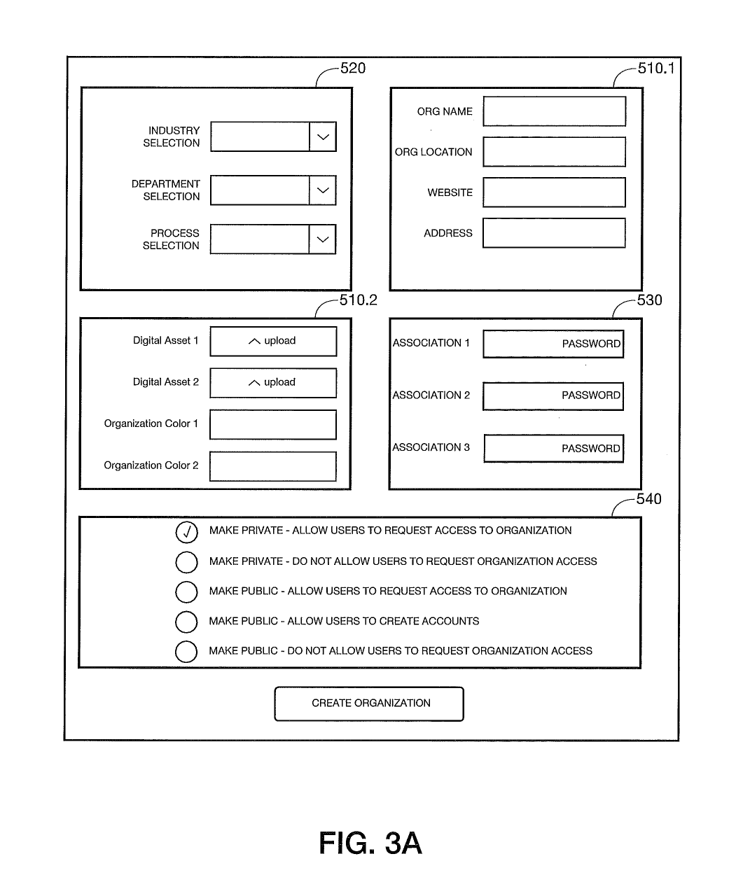

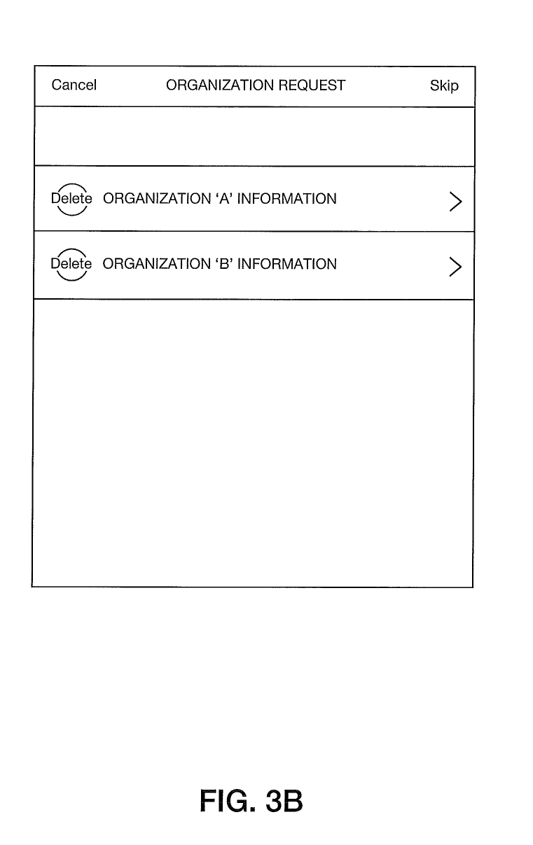

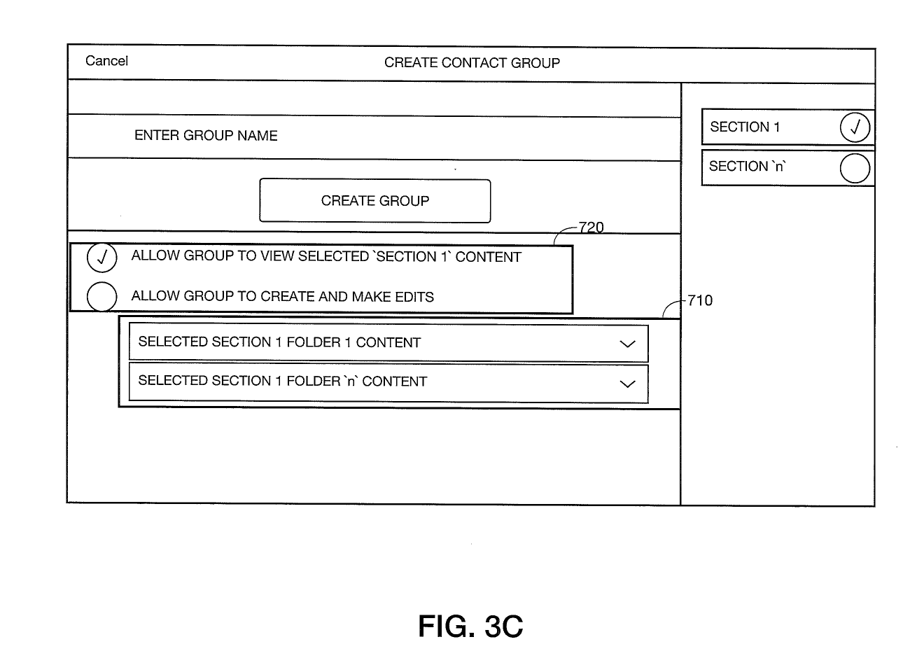

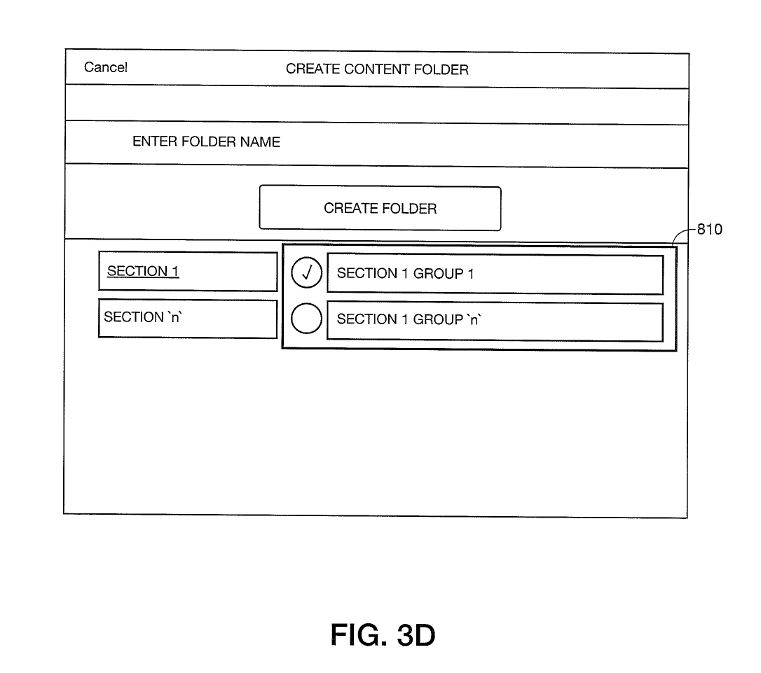

In Step 202, the application server 200 (FIGS. 1) responds to U1's request by providing U1 with an interface to enter organization information and corresponding network preferences for ON1. Referring for a moment to FIG. 3A, an interface that allows U1 to enter identifying information, including ON1's location and name, is shown by way of example. The interface may also allow U1 to enter other organization-related information for ON1 (e.g. website address, physical address, phone number, additional contact information, descriptions, etc.). The interface provided allows U1 to set visual characteristics for ON1's resulting graphical user interface (“GUI”), including colors to be used and digital assets to be presented. The interface may also allow U1 to select from additional visual options for ON1 (e.g. layout, button style, visual depth characteristics, and interface colorings).

Returning to FIG. 2A, at Step 203, U1 enters the information in the fields provided by the interface. As illustrated, the interface shown FIG. 3A provides the ability to select from drop down lists, manual and search based item entry, and radio buttons allowing U1 to define NAVIGATION, ASSOCIATION, and DEPLOYMENT properties, thereby giving U1 greater control over the contents of the resulting organizational structure of ON1.

At Step 204, U1 sets NAVIGATION, ASSOCIATION, and DEPLOYMENT preferences for the information entered in Step 203. As the three identifiers suggest, the NAVIGATION, ASSOCIATION, and DEPLOYMENT preferences refer, respectively, to the flow of information within the ensuing organizational network, the flow of information to other organization networks, and the flow of information to members. As further described below in conjunction with the interface illustrated in FIG. 3A, the NAVIGATION setting defines the capabilities and functionalities that make up ON1's interface elements (e.g., industry selection) that members may utilize, based on their respective permissions. The ASSOCIATION selection allows U1 to identify organizational relationships and request assimilation of ON1 into an existing networked structure (ON2) for the purpose of sharing and reporting digital content. Lastly, the DEPLOYMENT preference declares where and how ON1 will be accessed (e.g., public vs. private).

For certain embodiments, the information collected to create network organizations may be subdivided into different interfaces. Accordingly, after Step 205, U1 may repeat Steps 202 through 204 for additional preferences and information groups, as required by organization characteristics.

At Steps 206 and 207, the application server 200 identifies and builds ON1's navigational architecture and permissions structure from selected NAVIGATION and DEPLOYMENT preferences, respectively. This information is written to database 220 of system 100.

At Step 208, the application server determines if U1 declared an association with an existing parent organization on the network (ON2), an exemplary purpose being a business unit attempting to integrate with the parent company. In an embodiment, before updating the databases 220 and 240, the other organization network is required to confirm a request for network amalgamation to reflect organizational pairing. Doing so prevents ON1 from falsely claiming that the organizations are linked when they are, in fact, not. Delivery of ON1's request is made via the application server to ON2 in Step 209.

At Step 210, the application server 200 updates the databases 210 and 220 to reflect to association between U1 with ON1. At this point, the new organizational network has been created and the user can log in.

At Steps 211 through 214, the result of the request in Step 209 to ON2 is handled. and the databases 220 and 240 are updated. If the request is denied, Step 212 will notify ON1 of the declined association. Steps 213 and 214 rely on ON2's acceptance of ON1's request. Step 213 injects additional digital navigation paths, permissions, and digital assets to enable ON1 to send information to the parent ON2. Step 214, the application server ties ON1 with ON2.

As those skilled in the art will recognize, once ON1 has been created, U1 may create additional organizational networks or add additional organizational network associations at any time using the operations described above. Now that ON1 is on the system, additional operations will allow U1, and future ON1 members, depending on permissions level, which will be discussed in greater detail below with respect to FIG. 2C, to adjust and add content to ON1.

FIG. 2B is a flow diagram illustrating a method for processing a request from a registered user (U1) to add a new user (U2) to an organizational network (ON1) on the system. In Step 301, U1 enters contact information (in a preferred embodiment a first and last name are required) with an email being required for Step 302, or like identifying object (biometrics, social network identifier, phone number, etc.), to invite U2 to the organization.

In Step 303, the application server 200 responds to a request from a registered user (U1) to create a contact that will not be associated with the system 100. This would merely be a contact card on the system with no associated member.

At Step 304, the application server verifies current business requirements for organizational networks on the current system embodiment. Parallel systems may not require sub-organizations to maintain license seats. Step 304 ensures required licensing standards are met by ON1. Should a system license be requested, Steps 305 and 306 provide for licensing registration. These Steps may be repeated during future contact association requests if Step 304 calls ON1 to satisfy licensing requirements.

At Step 307, the application server places a hold on a license seat as the contact invitation request enters an outbound stage. At Step 308, the server determines if the contact information of U2 exists within database 210. Optimally, U2 would be found on the system, with Step 309 creating a profile representative of this fact via updating database 220.

In steps 310, 311, 312, 313, and 314, the opposite result of Step 309's request to database 210 is handled, and the databases 210 and 220 are updated. Step 310 creates a profile representative of U2 not being on the service, while being invited to ON1. Step 311 creates a temporary profile for U2, allowing the application server to deliver an organization request in Step 312. Both actions are completed via updates to database 210. At Step 313, the application server 200 sends an electronic request to U2's contact information.

In an embodiment, Step 314 is completed by U2 accepting ON1's network association invitation through creating an account. In Step 315, the application server would convert the profile information in databases 210 and 220 from Steps 310 and 311 to reflect U2's active profile state on the system. Unfortunately, not all invitations are received or acted upon in Steps 316 and 317, associated license holds are released, and databases 210 and 220 are updated.

In Step 318 U2 is made aware of ON1's pending network invitation. As further described below in conjunction with FIG. 4C, the invitation defines which organization(s) are requesting U2's network affiliation.

In an embodiment, Step 319 would be completed by U2 accepting the invitation of ON1. In Step 320, the application server would update database 210 and database 220, creating communications conductivity between U2 and ON1. As those skilled in the art will recognize, once U2 has been associated with ON1, U2 may interact with the organizational network using network operations.

Not all invitations are accepted. In Steps 321 and 322, associated license holds are released, and databases 210 and 220 are updated to reflect invitation rejection.

For some embodiments, the information presented to inform network organization requests and obligations may be subdivided into different interfaces. Accordingly, after Step 318, U2 may repeat Steps 318 through 204 for additional preferences and information groups, as required by organization characteristics.

Referring now to FIG. 2C, a flow diagram is shown which illustrates a method for dynamically managing the available interface elements and functionalities accessible to members of an organization distribution network. In Step 401 and 402, the application server 200 responds to requests from an administrative user (AU) to create a network contact group (CG) and data folder (DF), respectively, on the system 100. These situations arise when a user of sufficient permission level decide to create a new or edit an existing version of its application interface for organization members (OMs).

In Steps 403 and 404, the application server responds to AU's request by providing AU with an interface to enter identifying information and corresponding permission settings for CG and DF, respectively. FIG. 3C and 3D illustrates an interface that allows AU to enter identifying information, including title and sub-title of CG and DF. The interfaces may also allow AU to enter other visually defining characteristics (e.g. coloring, avatar, wallpaper, accessory, style, etc.).

At Step 405, AU enters the information in the fields provided by the interface in Step 403. As illustrated, FIG. 3C the interface provides a set of selection interfaces allowing AU to select VISIBILITY and INTERACTION preferences giving AU greater control over permission demarkation for OMs residing in the CG.

At Step 406, AU enters the information in the fields provided by the interface in Step 404. As more clearly illustrated in FIG. 3D, the interface provides a selection interface allowing AU to select DF's VISIBILITY setting, giving AU control over which OMs within DF's may interact with DF.

In Steps 407 and 408, AU sets VISIBILITY preferences for the information entered in Steps 405 and 406. Additionally, AU sets INTERACTION preferences for Step 405. As the two identifiers suggest, the VISIBILITY and INTERACTION preferences refer respectively, to the flow of sub-application availability and contents to OMs residing in CG's and to what extent OMs can interact with sub-application functionalities. The VISIBILITY setting for CG's are equal to the VISIBILITY selections for DF's; a change in CG visibility preferences will be reflected in the visibility preferences of DF for which the adjustment concerned. The INTERACTION preference, however, can only be set from CG to DF. Changes within DF VISIBILITY preferences will never inflict change upon a CG's associated INTERACTION preference.

At Step 409, the application server 200 updates the database 220 to reflect the new relations between CG's and DF's.

At Step 410, the application interface adds or removes functional elements as per the Step 409's changes to the database 220. As those skilled in the art will recognize, once AU has adjusted the CF of associated OMs, their interface will either present or hide network sub-applications and their associated functionalities. Changes in a CF can restrict content found in DF's, and the ability to use the DF's computational attributes.

Steps 411 and 412 allow AU to adjust the aforementioned preferences. For some embodiments, VISIBILITY and INTERACTION may be adjusted without collecting the groups of information, allowing editing of preferences only.

Referring now to FIGS. 3A, 3C, and 3D, three sample interfaces served on computers 500 for inputting information are shown in greater detail. FIG. 3A represents interface elements that may be used to input new organization network information. A new organization network is constructed, deployed, and represented by information, preferences, and settings selected during organization network creation. A registered user may enter information using text fields 510.1 and 510.2. The user selects NAVIGATION information through drop down menus or other list selection mechanisms. Each selection alters the capabilities and features of the resulting organizational network. The user selects ASSOCIATION information, or provides new inputs, through text entry, search, or through list selection via entry/selection fields 530. The user can use this information to request data sharing capabilities with the declared association, pending acceptance of an integration request. In addition to the above, radio buttons 540 are provided to allow the user to specify a DEPLOYMENT selection, allowing the organization to be publicly available or private, thereby providing a manner in which potential new organization network members become affiliated.

FIG. 3C represents interface elements that a user may engage with to create a contact group and adjust which sub-applications the members of this group may interact with and to what degree according to the method of FIG. 2C. Specifically, in accordance with an embodiment, FIG. 3C illustrates an interface allowing a user to enter the title of the group. The user may adjust whether or not the contact group has access to the selected section, or sub-application, via radio buttons 720. Selection menus 710 enable the user to choose the applicable components of the sub-application radio selection 720.

FIG. 3D represents interface elements that a user may engage with to create a data folder within a sub-application and select the contact folders which may interact therewith according to the method of FIG. 2C. The interface allows a user to enter the title of the data housing, according to one embodiment. The user may adjust selection menus 810 to make the data available to selected users or user groups of the organization network.

FIG. 3B illustrates a sample interface for negotiating invitations sent from organization networks to system users. A registered user may accept the invitation to the organization, giving the user access to the functionalities and data housed within the network, in accordance with the users organizational permissions. A user may also delete the invitation or choose to skip the process until later.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided by illustration only and not for the purpose of limitation.

What is claimed is:

1. A method for creating and managing an organization content distribution network, managing system, the system including one or more computer systems, each computer system including a plurality of processors, a plurality of databases, and an application server, the managing system being operatively connected to a network, the method comprising;
receiving, by one or more of the plurality of processors, information relevant to an organization for which the organizational content distribution network is being created from a first user associated with a member organization that has registered for the service provided by the computer system, the information influencing the resulting structure of the network created for the user's organization;
identifying, by one or more of the processors, the associated structural components related to the information relevant to the organization; and
sending, by one or more of the processors, organization information for the processing, assimilation, and creation of the user created organization network structure.

2. The method of claim 1 further including:
receiving, by one or more of the processors, a set of identifying data from the first user, the identifying data providing association information for other users, whether or not associated with the organizational network;
identifying, by one or more of the processors, a second user associated with the network based on the identifying data, the referenced identifying data for each second user being provided by the second user; and
sending, by one or more of the processors, network association requests for the identified one or more second users, whether or not associated with the network.

3. The method of claim 2 further including receiving, by one or more of the processors, permission compiling and associated structural data and information for building the network and creating the resulting network functionality and navigation paths.

4. The method of claim 1, wherein the information relevant to an organization comprises type, characteristic, nature, gender, name, location, contact information, description, digital art assets, organization digital multimedia assets, and common organization information, or any combination thereof.

5. The method of claim 1, wherein the organizational content distribution network comprises affiliated users of a simple organization, the users interacting with digital resources representing the users' common organization information.

6. The method of claim 1, wherein the user-created organization network structure comprises application contents, functionalities, sub-modules, sub-procedures, user interface layouts, user navigational structures, navigation IDs, security settings, preferences, licensing model(s), and interactions, or any combination thereof.

7. The method of claim 1, wherein the associated structural components comprise navigational constructs, data processing methods, and other software methods relevant to the selected organization type.

8. The method of claim 2, wherein the identifying data comprise one or multiple email addresses, phone numbers, social media usernames, or biometric login information, or any combination thereof.

9. The method of claim 2, wherein the association information comprise the selection of navigation IDs resulting in identification of contact folder location.

10. The method of claim 2, wherein the network association requests is delivered to either an active account of the system, or a shell account created for delivery purposes.

11. The method of claim 5, wherein the common organization information comprises the business, club, association, agency, or organizational entity, parent, division, conference, group, unit, or any level title, or any combination thereof.

12. The method of claim 3, wherein the permission compiling comprises visibility and interaction, and sub-divided sections of both, or any combination thereof.

13. The method of claim 3, wherein the associated structures comprise contact hierarchies and sub-network section utility, or any combination thereof.

14. The method of claim 3, further comprising receiving a request to view an organizations network interface adhering to permissions included in the permissions compiling.

15. The method of claim 3, further comprising accessing a permissions graph.

16. The method of claim 15, wherein the permissions graph includes a graph data structure comprising a plurality of nodes and a plurality of edges connecting the nodes, each one or more of the nodes being associated with one of the plurality of organization networks, each network being associated with one of the plurality of users of an online organizational network, each connection between two nodes being representative of permissions to view or take action upon the node, or establishing enrollment in the parent organization.
